(19) United States
(12) Patent Application Publication
(10) Pub. No.: US 2021/0167349 A1
(43) Pub. Date: Jun. 3, 2021

(54) Batteries and Methods of Using and Making the Same

(71) Applicant: EaglePicher Technologies, LLC, St. Louis, MO (US)

(72) Inventors: Dong Zhang, Webb City, MO (US); Jason A. Mudge, Joplin, MO (US); David Timothy Andrew Darch, Neosho, MO (US); Mario Destephen, Joplin, MO (US); Ernest Ndzebet, Carl Junction, MO (US); Umamaheswari Janakiraman, Webb City, MO (US)

(73) Assignee: EaglePicher Technologies, LLC, St. Louis, MO (US)

(21) Appl. No.: 16/701,156

(22) Filed: Dec. 3, 2019

(51) Int. Cl. H01M 2/26; H01M 6/02; H01M 4/38; H01M 4/74

(52) U.S. Cl. CPC H01M 2/26; H01M 6/02; H01M 2004/021; H01M 4/742; H01M 4/382

(57) ABSTRACT

The disclosure provides a cell that may comprise (1) a housing; (2) an anode current collector, in the housing, including a first connection, and the anode current collector including a first plate with perforations and a second plate with perforations, the anode current collector further including a tab that connects the first plate and the second plate; (3) a cathode current collector, in the housing, including a second connection; (4) a first anode, in the housing, provided between the cathode current collector and the first plate; (5) a second anode, in the housing, provided between the cathode current collector and the second plate; and (6) a cathode, in the housing, provided adjacent to the cathode current collector. The disclosure may also provide systems and methods of making such a cell.

### BACKGROUND

The disclosed subject matter relates to a battery, and methods of use and manufacture thereof. More particularly, the disclosed subject matter relates to a battery with one or more cells provided with an anode current collector.

The technical field of the disclosure is primary lithium batteries. The term “primary” can denote a non-rechargeable electrochemical cell, in contrast to the term “secondary” which can denote a rechargeable electrochemical cell. A battery may include one or more cells.

Primary lithium batteries may include those having metallic lithium anode, pairing with various cathodes, including Li/CFₓ, Li/MnO₂, Li/SVO, Li/Hybrid, Li/SOCl₂. During the discharge of such a battery, the oxidation of the lithium metal to lithium ions may take place at the anode according to the following reaction:

Li→Li⁺+e

At the cathode, the reduction of the oxidizing substance can take place. In the case where the oxidizing agent is CFx, the reduction reaction may be as follows:

CFₓ+e+xLi⁺−C+xLiF

During discharge, the oxidation of the lithium metal to lithium ions occurs at the anode, and the lithium ions leave anode surface and migrate into porous cathode. At the cathode during discharge, the insertion of lithium into CFₓ takes place, producing insoluble lithium fluoride and graphite (an electronic conductor).

Primary cells may be constructed with a spirally wound assembly of an anode. In such arrangement, the anode can be constituted with a laminated current collector strip on a lithium foil. The current collector can be a copper strip. The cell negative terminal tab may be connected to the lithium foil and copper strip.

However, there are various problems associated with the above described and other known technology.

### SUMMARY

The disclosure provides a cell that may comprise (1) a housing; (2) an anode current collector, in the housing, including a first connection, and the anode current collector including a first plate with perforations and a second plate with perforations, the anode current collector further including a tab that connects the first plate and the second plate; (3) a cathode current collector, in the housing, including a second connection; (4) a first anode, in the housing, provided between the cathode current collector and the first plate; (5) a second anode, in the housing, provided between the cathode current collector and the second plate; and (6) a cathode, in the housing, provided adjacent to the cathode current collector. The disclosure may also provide systems and methods of making such a cell.

Various further aspects and features of the disclosure are described below.

### BRIEF DESCRIPTION OF THE DRAWINGS

The disclosed subject matter of the present disclosure will now be described in more detail with reference to exemplary embodiments of the apparatus and method, given by way of example, and with reference to the accompanying drawings, in which:

FIG. 1 is a diagram showing an electrochemical cell with detail of an anode current collector 100, in accordance with one or more embodiments.

FIG. 2 shows an exploded view of an electrochemical cell the same as or similar to the cell 10 of FIG. 1, in accordance with one or more embodiments.

FIG. 3 is a cross-section view, along line 3-3 of FIG. 1, of an electrochemical cell the same as or similar to the cell of FIG. 1, in accordance with one or more embodiments.

FIG. 4 is a perspective view of the anode current collector to which can be attached two lithium coupons (or anodes), in accordance with one or more embodiments.

FIG. 5 is an example of an anode current collector (in a flat form), in accordance with one or more embodiments.

FIG. 6 is a perspective view of the anode current collector and two lithium coupons (i.e. anodes), in accordance with one or more embodiments.

FIG. 7 is a perspective view of a header assembly of a battery showing details of the cell of FIG. 2, in accordance with one or more embodiments.

FIG. 8 is a cross-section view, along line 8-8 of FIG. 7, of a header assembly the same as or similar to the header assembly of FIG. 1, in accordance with one or more embodiments.

FIG. 9 is a top view of a header assembly in accordance with one or more embodiments.

FIG. 10 is a bottom perspective view of a header assembly of FIG. 1, in accordance with one or more embodiments of the disclosure.

FIG. 11 is a top perspective view of a header assembly of FIG. 1, in accordance with one or more embodiments of the disclosure

### DETAILED DESCRIPTION OF EXEMPLARY EMBODIMENTS

A few inventive aspects of the disclosed embodiments are explained in detail below with reference to the various drawing figures. Exemplary embodiments are described to illustrate the disclosed subject matter, not to limit its scope, which is defined by the claims. Those of ordinary skill in the art will recognize a number of equivalent variations of the various features provided in the description that follows.

The present disclosure relates generally to the technical field of primary batteries such as batteries for implantable medical devices. More particularly, for example, the present disclosure relates to lithium/fluorinated carbon (Li/CFₓ) batteries for use in an implantable cardiac monitor (ICM) device or other implantable medical products.

As described herein, there are various problems with known technology relating to batteries.

One problem is that discharge efficiency may be low for the metallic lithium anode of the electrochemical cells described above. At the end of the discharge of an Li/CFₓ or Li/MnO₂ cell, undischarged lithium zones may appear on the anode. The quantity of residual metallic lithium, especially at low discharge rates, is significant since it can be up to 25% of the quantity of lithium for a cell in the undischarged state. An increase in the width of the current collector may help solve the problem. However, the wider current collector then masks too large a part of the electrochemically active area of the lithium. Thus, a simple increase in collector width is not a sufficient solution.

An optimized current collector for a primary lithium electrochemical cell is therefore sought, having a quantity of residual lithium less than those of the prior art. The reduction in the quantity of residual lithium at the end of discharge will result in an increase in the discharge capacity, and thus the energy density, of the electrochemical cell.

U.S. Pat. No. 4,482,615 describes a primary battery of Li/SO₂ type, in which the anode is composed of a lithium foil laminated with a copper strip current collector. The ratio of the surface area of the copper strip to the surface area of the metallic lithium foil is from 0.02 to 0.25. A copper wire can replace the copper strip to serve the same function. This assembly is directed to providing a primary lithium battery having increased safety in the case of forced discharge.

JP 2017152243 discloses that perforated plates are used as positive electrode current collector and the negative electrode current collector for a rechargeable lithium-ion battery.

Information on perforated current collector foils for Li-ion batteries is published on Fraunhofer Institute for Laser Technology ILT website at www.ilt.fraunhofer.de.

The present disclosure pertains to an electrochemical cell that converts chemical energy to electrical energy. A battery, in accordance with one or more embodiments, may include one or more electrochemical cells of the disclosure, which may be electrically connected or wired to each other, and to respective exterior connections. Specifically, the disclosure pertains to an electrochemical cell having a cathode, stable electrolyte, a separator and a lithium anode on a perforated metallic current collector. The anode current collector design is a notable aspect of this disclosure, which provides an implantable electrochemical cell having high utilization of lithium anode material—and consequently high specific energy. The cell is useful in implantable cardiac monitor (ICM) devices, other implantable medical products, and other devices.

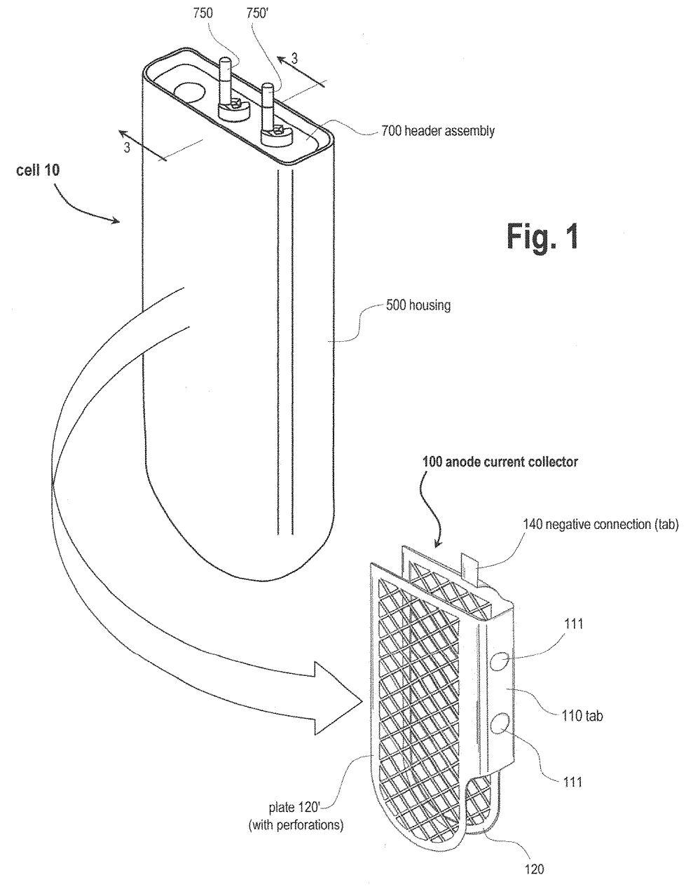

FIG. 1 is a diagram showing an electrochemical cell 10 with detail of an anode current collector 100, in accordance with one or more embodiments. The cell 10 includes a housing or case 500 and a header assembly 700. The housing 500 in conjunction with the header assembly 700 contains various components as described in detail below. In particular, the cell 10 includes an anode current collector 100, as described in detail below.

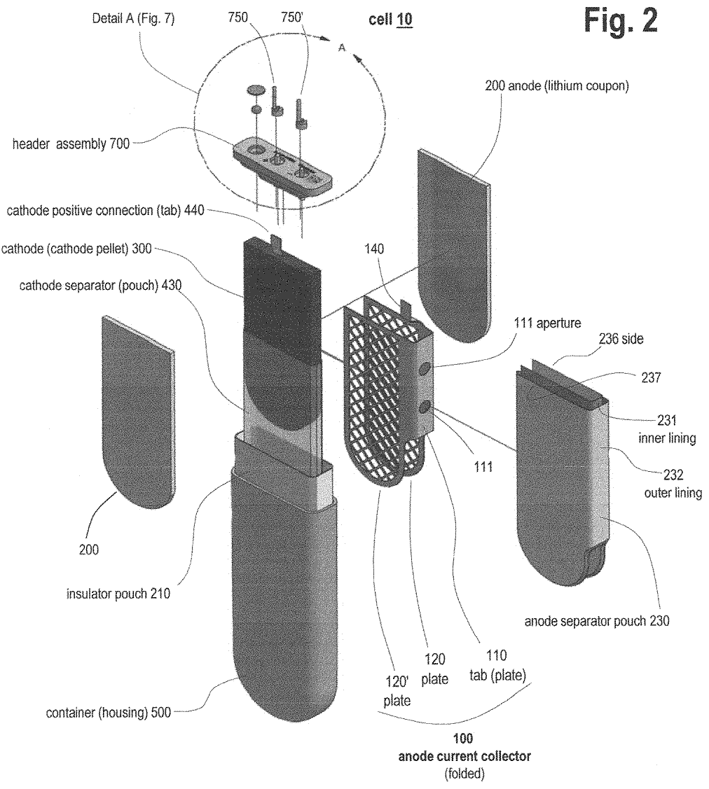

FIG. 2 shows an exploded view of an electrochemical cell 10 the same as or similar to the cell 10 of FIG. 1, in accordance with one or more embodiments.

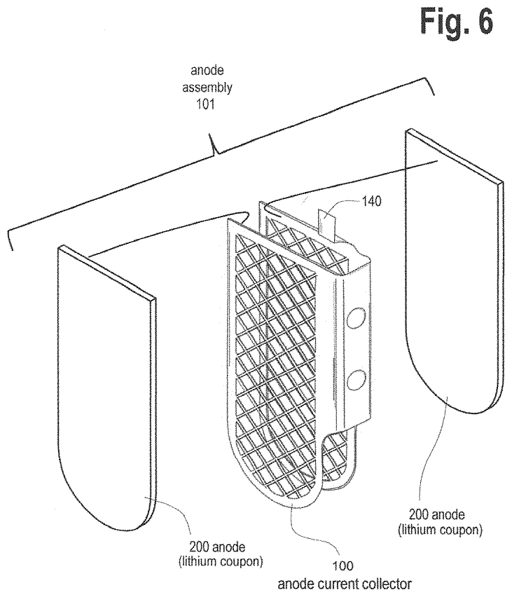

As shown in FIG. 2, the cell 10 includes at least one anode 200 (as shown two anodes 200) and an anode current collector 100. The anode 200 may comprise one, two or more metallic lithium coupons 200, pressed onto the current collector 100. The (a) anodes 200, which may be constituted by lithium coupons, and (b) anode current collector 100 can collectively be characterized as an anode/anode current collector assembly 101 or lithium coupon/anode current collector assembly 101, or simply characterized as an anode assembly 101 as shown in FIG. 6, for example, and further described below.

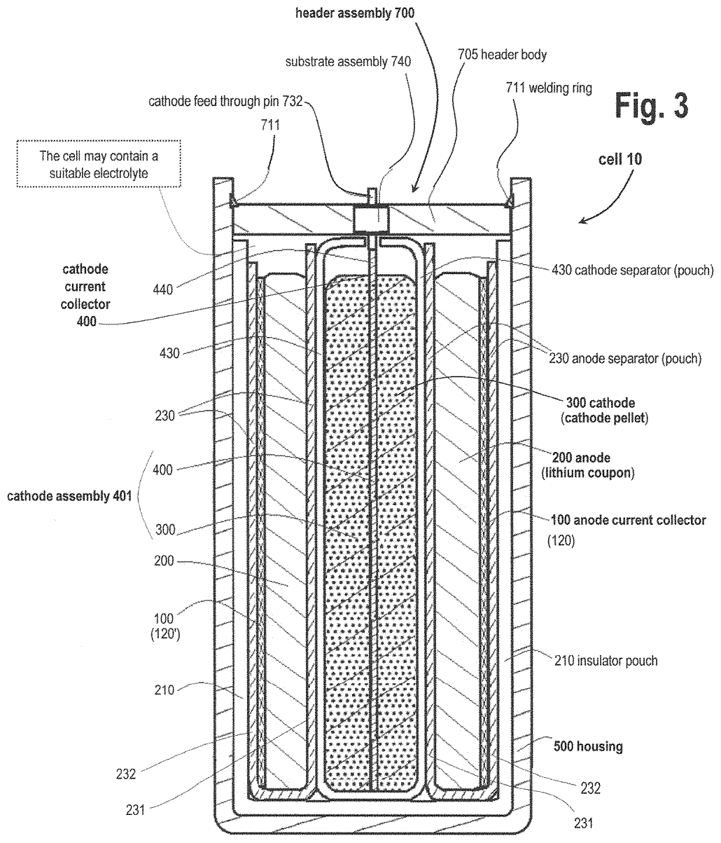

Relatedly, the cathode current collector 400 and the one or more cathode/cathode pellets 300 can be characterized as a cathode assembly 401, as shown in FIG. 3.

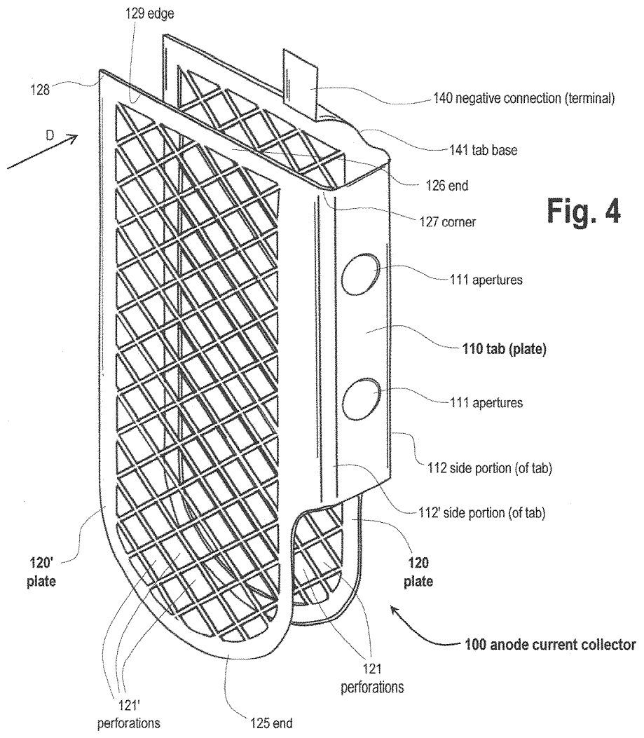

The anode current collector 100 may be constructed of material such as stainless steel or copper, for example. The current collector 100, as also shown in FIG. 4, is perforated 121 in accordance with one or more embodiments. The perforations 121 may be diamond shape, circular shape, rectangular shape, square shape and/or other shapes. The ratio of perforated area to the total area of the collector (excluding the central folding and tabbing area) may be about 0.6, for example, in accordance with one or more embodiments, and as otherwise described herein. The thickness of the current collector 100 may be about 0.050 mm. An alignment feature 110, 111 may be provided in the center of the current collector 100 that facilitates proper anode to current collector alignment and proper anode current collector folding, which may be key steps in cell construction. The electrochemical cell of FIG. 2 includes two lithium coupons, i.e. anodes, 200 and one folded anode current collector 100. The perforations 121 in a particular anode current collector 100 may be of different shape, such as some perforations having a diamond shape and some perforations having a rectangular shape, for example.

Such electrodes, i.e. the lithium coupons 200, may be advantageously used as the anode of a primary lithium electrochemical cell, for example of various cathode types such as the Li/CFₓ type with x comprised between 0.6 and 1.2, the Li/MnO₂ type, or the Li/SVO type (where SVO is silver vanadium oxide), in order to reduce the quantity of undischarged residual lithium and to increase consistency in discharge capacity.

An aspect of the disclosure is also a primary electrochemical cell with a non-aqueous electrolyte comprising one or more anodes, as described herein. The primary electrochemical cell may be provided with a non-aqueous electrolyte including Li/CFₓ, (where x is comprised between 0.6 and 1.2), Li/MnO₂, Li/SVO, or Li/hybrid, where the hybrid is a mixture of CFₓ, and/or MnO₂, and/or SVO, for example.

FIG. 2 and FIG. 3 show further detail of the interrelationship of the various components of the cell 10. As described above, the cell 10 includes the housing 500 and the header assembly 700. The housing 500 in conjunction with the header assembly 700 contains various components of the cell including electrolyte of the cell.

An insulator pouch 210 may be provided inside the housing 500 so as to provide a lining to the housing 500. As shown in FIG. 3, for example, inside the insulator pouch 210 is provided an anode separator 230. The anode separator 230 may be in the form of a folded pouch, as also shown in FIG. 2, so as to form two sides 236, 237. Accordingly, the anode separator pouch 230 may be in a folded arrangement as shown in FIG. 2. The anode separator pouch 230 may include an inner lining 231 and an outer lining 232. Inside each side of the anode separator pouch 230 may be positioned both anode 200 and plates 120, 120′ of anode current collector 100, in accordance with one or more embodiments. The anode 200 may be in the form of a lithium coupon 200. The lithium coupons 200 can be respectively positioned on the anode current collector plates 120, 120′, so as to form the anode assembly 101. As shown in FIG. 3, the lithium coupons 200 are positioned on an interior side of the respective collector plate 120, 120′ to which each is attached. The lithium coupon/anode current collector assembly 101, i.e. the anode assembly 101, is enclosed in the anode separator pouch 230 with open or closed top. With regard to the anode separator pouch 230, the inner lining 231 height can be greater than the outer lining 232 height, to provide good isolation between a cathode assembly 401 and anode assembly 101. In accordance with one or more embodiments of the disclosure, the anode current collector 100 and anodes 200 can be slid into the anode separator pouch 230 from above the anode separator pouch 230, i.e. slid into the top of the anode separator pouch 230. In particular, (1) one side of the anode assembly 101 (plate 120, anode 200) can be slid into one side of the anode separator pouch 230 between the outer lining 232 and the inner lining 231, in conjunction with (2) the other side of the anode assembly 101 (plate 120′, anode 200) can be slid into the other side of the anode separator pouch 230 between the outer lining 232 and the inner lining 231. As a result, the arrangement illustrated in FIG. 3 can be provided.

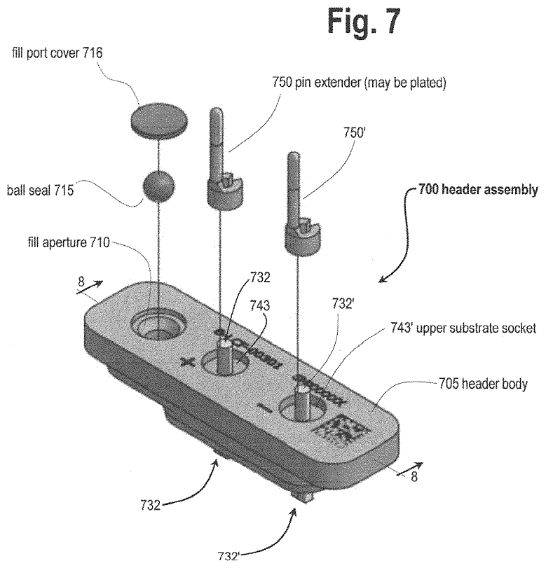

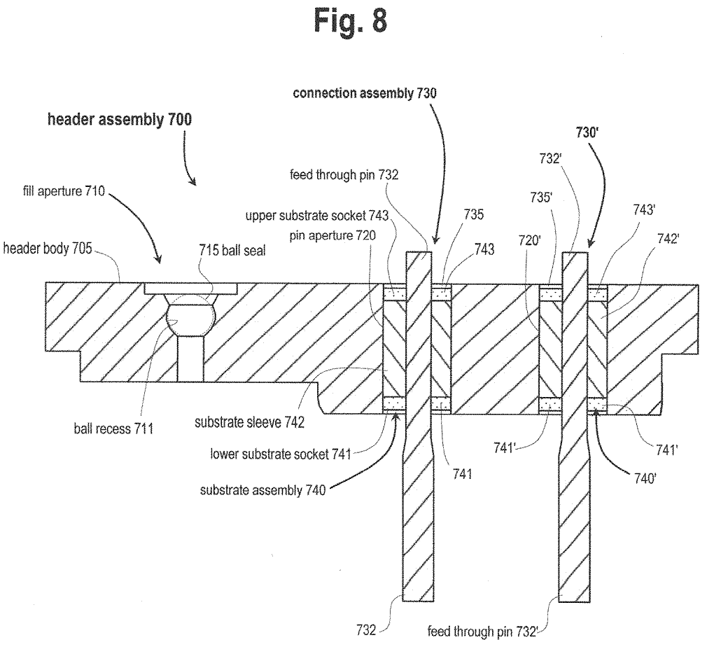

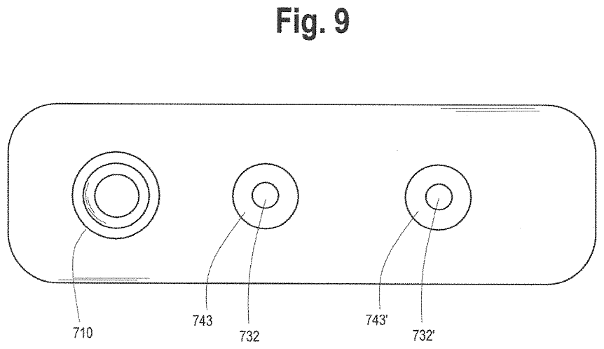

As shown in FIG. 2 and FIG. 3, the housing 500 also includes a cathode separator 430, which may be in the form of a cathode separator pouch 430. The cathode separator pouch 430 may be provided between the two sides 236, 237 of the anode separator pouch 230, as such is folded. Provided within the cathode separator pouch 430 is one or more cathodes 300 and a cathode current collector 400. Each cathode 300 may be constituted by a cathode pellet 300. Dimensions of the cathode 300 are shown in FIG. 2 and FIG. 3. The cathode current collector 400 may be provided in the form of a plate that is provided between the two cathodes 300. The cathode current collector 400, i.e. plate for example, may be constituted and/or include a body that extends throughout a substantial extent of the width and height of the cathode(s) 300. A cathode connection 440 or cathode positive connection 440 may be integrally formed with the cathode current collector 400 and extend above the cathodes 300 as is shown in both FIG. 2 and FIG. 3. The cathode positive connection 440 may engage with a corresponding connection in header body 710. For example, the cathode positive connection 440 may engage with, as shown in FIG. 3, cathode feedthrough pin 732. Relatedly, the negative connection or tab 140 of the anode assembly 101 may engage with a corresponding connection in header body 710. Further details are described below with reference to FIGS. 7 and 8, for example.

In accord with at least some embodiments of the disclosure, a header assembly 700 is shown in FIG. 2 and FIG. 3 and is shown in further detail in FIG. 7. The header assembly 700 includes a header body 705. The header body 705 may be shaped so as to conform and mate with an inner periphery of the housing 500. For example, one or more welding rings 711 (FIG. 3) or other connection structure may be utilized to attach the header assembly 700 to the housing 500 at a desired position.

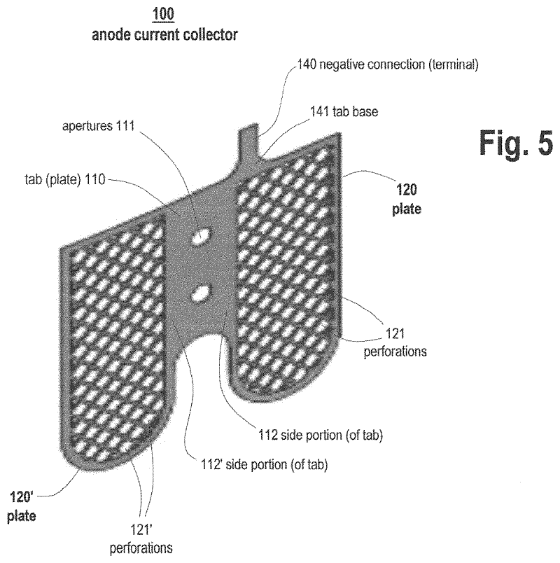

FIG. 4 shows anode current collector 100 in a folded state. According to one or more embodiments, as described above, two metallic lithium coupons 200 are used as the anode of the electrochemical cell, as shown in FIGS. 2, 3 and 6, for example. The lithium coupons 200 may be respectively fixed or positioned adjacent to the anode current collector 100. FIG. 5 represents a flat view of a metallic current collector 100, in accordance with one or more embodiments. That is, FIG. 5 shows an anode current collector 100 in a flattened or unfolded state. As shown in FIG. 4 and FIG. 5, the anode current collector 100 includes a first plate 120, a second plate 120′, and a tab or bridge plate 110 that serves to connect the plates 120, 120′. The current collector 100 can include perforations. More specifically, the plates 120, 120′ may be provided with perforations 121, 121′. The plates 120, 120′ may be flat or substantially flat as shown in FIG. 4, i.e. in an operational configuration as shown in FIG. 4. Alternatively, the plates 120, 120′ may be some other shape (and not flat), such as curved in a direction along tab 110 and/or curved in a direction perpendicular to a length of the tab 110, for example.

From the perspective along direction D in FIG. 4, the plate 120 may be the same shape as the plate 120′. For example, the plate 120 may include a first end 125 and a second end 126, with the first end being rounded and the second end defined by two corners 127, 128 and linear edge 129 extending between such two corners 127, 128. In general, as otherwise described herein, the plate 120 may be mirror image of, and have the same structure as, the plate 120′.

As shown in FIG. 5 and FIG. 4, the current collector 100 also may be provided with alignment features including solid tab or plate 110 in the center of the anode current collector 100. The solid tab or plate 110 may be characterized as a bridge plate in that tab 110 bridges between the plate 120′ and the plate 120. The tab 110 may be provided with a plurality of apertures 111. The lithium coupons 200 can be positioned on the anode current collector plates 120, 120′ (for example, on an interior side of the anode current collector plates 120, 120′), and the anode current collector 100 can be folded to the shape of design. The one or more apertures 111 can serve as an alignment feature during anode assembling process or assembling process of the cell 10. The apertures 111 can help the anode current collector 100 be positioned on a fixture or assembly, and can assist to allow consistent and accurate placement of one or more lithium coupons 200 at or on the correct position on the anode current collector 100, i.e. on the plates 120, 120′. In addition, the apertures 111 can help fold the current collector correctly. As shown in FIG. 5, the tab 110 can include a side portion 112. The plate 120 is attached along the side portion 112. The tab 110 can also include a side portion 112′. The plate 120′ is attached along the side portion 112′.

Accordingly, the tab 110 can have a plurality of apertures 111 that include a first aperture and a second aperture, and the first aperture positioned over the second aperture in the tab. The first aperture and the second aperture can each be centered in the tab 110 between a first side portion 112 and the second side portion 112′, as shown in FIG. 4, for example.

As shown in FIG. 5, the anode current collector 100 may also be provided with a negative connection, terminal or tab 140, in accordance with one or more embodiments of the disclosure. The negative connection 140 may be a terminal, tab, or similar structure that extends from one of the plates 120, 120′ or may extend from the tab 110. The connection 140 may include a tab base 141 that is widened and/or may be of structure or shape as desired.

The proportion of perforation can be defined as the ratio of (a) surface area (or otherwise characterized as the lack of surface area) of the perforation void of material to (b) total surface area of the collector excluding the central folding and tab area, in accordance with one or more embodiments. With reference to FIG. 4, which shows the anode current collector 100 in a folded state, a tab area may be characterized as the area of the anode current collector 100 that is provided substantially in the same plane as the apertures 111, i.e. substantially co-planer to the apertures 111, and the turned corners or edges along each side portion 112, 112′ of the tab 110. In accordance with one or more embodiments, the proportion of perforation of a current collector may be between 30% and 90%, preferably may be between 40% and 80%, or preferably may be between 50% and 70%, for example. The current collector 100 may allow uniform utilization of lithium coupons during discharge. At the same time, the perforated anode current collector 100 can occupy a minimal amount of volume inside the cell 10, allowing maximization of the amount of electrochemically active components in the cell 10 and—as a result—provide high energy density.

In accordance with one or more embodiments, the total surface area of the current collector excluding the central folding and tab area may be equal to or be a little smaller than the area of the lithium coupons. In accordance with one or more embodiments, the ratio of the surface area of the current collector (excluding the central folding and tab area) to the area of the lithium coupons may be between 70% to 100%, preferably may be between 80% and 100%, or preferably may be between 90% and 100%. Such ratio of the surface area of the current collector (excluding the central folding and tab area) to the area of a lithium coupon may relate to one side (i.e. plate) 120, 120′ of the anode current collector 100 vis-à-vis a corresponding lithium coupon (i.e. anode) 200 pressed onto or associated with such respective plate 120, 120′, for example. Relatedly, it is appreciated that the provided structure including the two sides of the anode current collector 100 and associated anode 200 may be mirror image of each other, i.e. such that ratios of such mirror image structure would be the same.

The current collector 100 may be a perforated metal, a stamped metal, an expanded metal, a grid, or a metallic fabric, for example. Thickness of the current collector 100 preferably may be between 0.010 mm and 0.100 mm, preferably may be between 0.020 mm and 0.070 mm, and preferably may also be between 0.04 and 0.06 mm. The material serving as a current collector is preferably chosen from the group comprising copper, stainless steel, nickel and/or titanium, for example. In accordance with one or more embodiments, preferably, the material may be pure copper—as pure copper has a high electric conductivity.

The alignment feature in the center of the current collector assists proper anode to current collector alignment and anode current collector folding, which may be key aspects of cell construction, in accordance with one or more embodiments.

As illustratively shown in FIG. 4 and described above, for example, two holes, openings, or apertures 111 in the center of the tab 110 allow the current collector to sit, be supported and/or be seated on a fixture in a stationary disposition. In such disposition, the lithium coupons or anodes 200 can be pressed properly onto the current collector 100. Also, the two or more holes 111 afford a void of material that may allow easier folding of the current collector. Such arrangement may provide for (a) proper and/or needed geometry of the anode current collector 100 and other components within the cell, and (b) proper sandwiching of the cathode assembly 401 to fit into the cell case or housing 500. The lithium coupons 200 can be positioned on the anode current collector plates 120, 120′, and the anode current collector 100 can be folded to the shape of design, such as shown in FIG. 4. The aperture(s) 111 may serve as alignment feature during an assembling process. The apertures can help the anode current collector 100 be positioned on a support structure, and assists to allow consistent placement of a lithium coupon(s) 200 at the correct position on the anode current collector 100. In addition, the aperture(s) 111 can help fold the current collector 100 correctly.

In accordance with one or more embodiments of the disclosure, the apertures 111 can be fitted on or into a jig or assembly structure in the assembly process, so as to support the anode current collector 100. For example, the apertures 111 can be fitted over a pair of protuberances or studs (in or on an assembly structure) that match with the apertures 111. As a result, the anode current collector 100 can be accurately positioned on the assembly structure. The anodes 200, e.g. lithium coupons, can also be supported or positioned on the support structure on a respective, defined support that accurately positions the anodes 200 on the support structure. As a result of the accurate positioning of the lithium coupons 200 and the accurate positioning of the anode current collector 100 on the support structure, in the assembly process, each anode 200 can be accurately positioned on a respective plate of the plates 120, 120′.

Such a support structure can be positioned in the interior of the anode current collector 100 so as to support the anode current collector 100 and so as to be positioned to support the anodes 200. Such a support structure can also include bend plates that approach or sweep up on opposing sides of the supported anode current collector 100, so as to bend each plate 120, 120′ from a disposition shown in FIG. 5 to a disposition as shown in FIG. 4. Such an assembly process may also include heat applied, such as to the anode current collector 100.

As described above, the anode current collector 100 may include a negative current output terminal or connection 140 of the cell, which can be connected either to the current collector tabbing, or to the metallic lithium strip, or to both, for example.

In accordance with one or more embodiments, an electrode according to the disclosure can be used as an anode (negative electrode) of a primary lithium battery with a non-aqueous electrolyte. The electrolyte can be a salt (such as LiBF₄) dissolved in organic solvent or in a mixture of solvents.

The primary electrochemical cell can be the types of Li/CFₓ, (where x is comprised between 0.6 and 1.2), Li/MnO₂, Li/SVO, or Li/hybrid, where hybrid is a mixture of CFₓ, and/or MnO₂, and/or SVO.

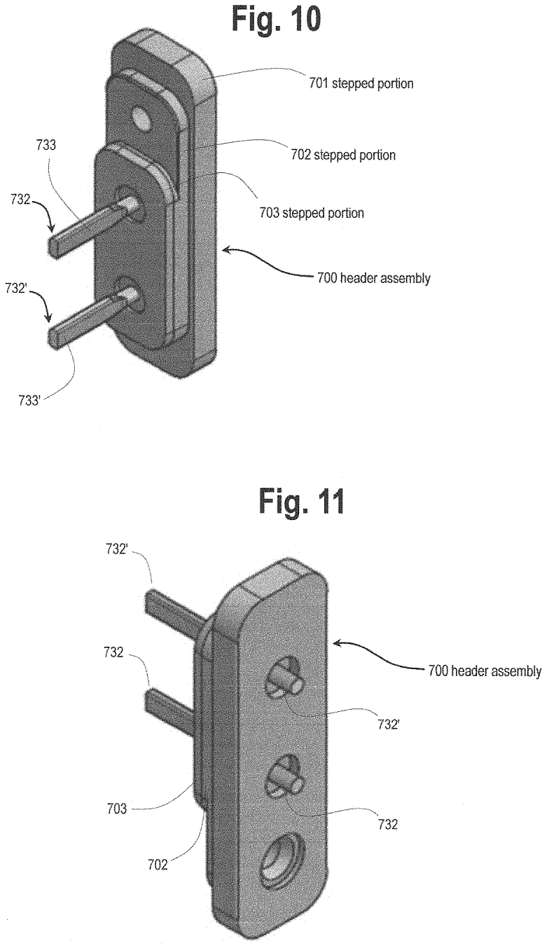

FIG. 7 is a perspective view of a header assembly of a battery, showing Detail A of FIG. 2, in accordance with one or more embodiments. FIG. 8 is a cross-section view, along line 8-8 of FIG. 7, of a header assembly the same as or similar to the header assembly of FIG. 1, in accordance with one or more embodiments. As shown in FIG. 7, the header assembly includes a header body 705. The header body 705 may be dimensioned so as to be received into housing 500. The header body may be stepped 701, 702, 703 (FIG. 10) so as to accommodate components supported by the header body 705 as well as components positioned adjacent to the header body 705.

The header body 705, as shown in FIGS. 7 and 8, includes a fill aperture 710. The fill aperture 710 may be provided to add or remove electrolyte from the cell. The fill aperture 710 may be provided with a valve to prevent fluid flow there through. In accordance with one or more embodiments, the valve may be a ball valve, with the fill aperture dimensioned about a centerline so a receive a ball seal 715. A fill port cover 716 may be provided to cover the fill aperture 710 and valve of the aperture.

As shown in FIG. 7, the header body 705 may also be provided with at least one pin aperture 720. The pin aperture 720 is provided to accommodate a connection assembly 730. The connection assembly 730 provides an electrical path from an interior of the housing, in which the cell is located, through the connection assembly 730, to an exterior of the housing. In accordance with one or more embodiments, the connection assembly 730 includes a feed through pin 732. The feed through pin 732 provides a conductive path through the header body 705. The feed through pin 732 may be supported by a substrate assembly 740. The substrate assembly 740 can include a lower substrate socket 741, a substrate sleeve 742, and an upper substrate socket 743. The substrate assembly 740 can provide a seal around and/or provide support to the feed through pin 732 in the pin aperture 720. The lower substrate socket 741 and the upper substrate socket 743 can be annular in shape, i.e. donut shaped, so as to encircle the feed through pin 732. The lower substrate socket 741 and the upper substrate socket 743 may be glass, resin or other suitable material. The lower substrate socket 741, upper substrate socket 743, and substrate sleeve 742 can be constructed of insulating material.

The feed through pin 732 may be connected to respective mating electrical connections. The feed through pin 732 may be connected to a pin extender 750 as shown in FIG. 7. The pin extender 750 may mate with the feed through pin 732 in telescopic manner as shown, or in other suitable manner. Relatedly, the header body 705 may be provided with an annular recess 735 so as to receive at least a portion of the pin extender 750—so as to provide a more secure, stable and supported connection engagement. The annular recess 735 can be provided or defined by the pin aperture 720 and a top surface of the upper substrate socket 743.

The feed through pin 732 may be connected to the cathode positive connection or tab 440 so as to provide electrical connection between the cathode current collector 400 and the pin extender 750. The feed through pin 732 may be dimensioned or flattened 733 on one or more sides as shown in FIG. 10 and FIG. 11 so as to effectively engage with the tab 440 or other connection and accordingly provide electrical connection between the cathode current collector 400 and the pin extender 750.

The header assembly 700 may also be provided with connection assembly 730′. The connection assembly 730′ provides an electrical path from an interior of the housing, in which the cell is located, through the connection assembly 730′, to an exterior of the housing. In accordance with one or more embodiments, the connection assembly 730′ can include a feed through pin 732′. The feed through pin 732′ may be supported by a substrate assembly 740′. The substrate assembly 740′ can include a lower substrate socket 741′, a substrate sleeve 742′, and an upper substrate socket 743′. The substrate assembly 740′ can provide a seal around and/or provide support to the feed through pin 732′ in a pin aperture 720′. The lower substrate socket 741′ and the upper substrate socket 743′ can be annular in shape, i.e. donut shaped, so as to encircle the feed through pin 732′. The lower substrate socket 741′ and the upper substrate socket 743′ may be glass, resin or other suitable material. The lower substrate socket 741′, upper substrate socket 743′, and substrate sleeve 742′ can be constructed of insulating material.

The feed through pin 732′ may be connected to respective mating electrical connections. The feed through pin 732′ may be connected to a pin extender 750′ as shown in FIG. 7. In particular, the pin extender 750′ may mate with an upper end of the feed through pin 732′ in manner as shown, or in other suitable manner. Relatedly, the header body 705 may be provided with an annular recess 735′ so as to receive at least a portion of the pin extender 750′—so as to provide a more secure and supported connection engagement. The annular recess 735′ can be provided or defined by the pin aperture 720′ and a top surface of the upper substrate socket 743′.

The feed through pin 732′ may be connected to the anode negative connection or tab 140 so as to provide electrical connection between the anode current collector 100 and the pin extender 750′, in accordance with one or more embodiments of the disclosure. The feed through pin 732′ may be dimensioned or flattened 733′ on one or more sides as shown in FIG. 10 and FIG. 11 so as to effectively engage with the tab 140 or with another connection assembly, and accordingly provide electrical connection between the anode current collector 100, with tab 140, and the pin extender 750′.

Both the pin extender 750 and the pin extender 750′, as shown in FIG. 7 may be plated and/or otherwise enhanced so as to provide good electrical connection to yet further electrical respective connections, i.e. that are placed or positioned, respectively, onto the pin extender 750 and the pin extender 750′.

The connection assembly 730 and the connection assembly 730′ may be of the same or similar construct. The connection assembly 730 and the connection assembly 730′ may provide respective pass-through connections so as to provide electrical connection between the interior and the exterior of the cell.

As shown in FIGS. 10 and 11, for example, the header assembly 700 may included first stepped portion 701, second stepped portion 702, and third stepped portion 703. The stepped portions 701, 702, 703 may be shaped and dimensioned so as to provide for the fill aperture 710, to provide desired stability and support to the feed through pins 732, 732′, and so as to accommodate or support other components as described herein.

In accordance with one illustrative example, one anode can be prepared from two metallic lithium coupons with a perforated current collector made of copper. The copper current collector can be perforated with diamond shape perforations. The ratio of perforated void area to the total area of current collector (excluding the central folding and tabbing area) can be 0.6. The thickness of the current collector can be 0.050 mm. The cell negative terminal can be connected to a negative connection or tab 140 of the current collector.

It is appreciated that the various components of embodiments of the disclosure may be made from any of a variety of materials including, for example, metal, copper, stainless steel, nickel, titanium, plastic, plastic resin, nylon, composite material, glass, and/or ceramic, for example, or any other material as may be desired.

A variety of production techniques may be used to make the apparatuses as described herein. For example, suitable casting and/or injection molding and other molding techniques, bending techniques, and other manufacturing techniques might be utilized. Also, the various components of the apparatuses may be integrally formed, as may be desired, in particular when using casting or molding construction techniques.

The various apparatuses and components of the apparatuses, as described herein, may be provided in various sizes, shapes, and/or dimensions, as desired.

It will be appreciated that features, elements and/or characteristics described with respect to one embodiment of the disclosure may be variously used with other embodiments of the disclosure as may be desired.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present.

It will be understood that when an element or layer is referred to as being “onto” another element or layer, the element or layer can be directly on another element or layer or intervening elements or layers. Examples include “attached onto”, secured onto”, and “provided onto”. In contrast, when an element is referred to as being “directly onto” another element or layer, there are no intervening elements or layers present. As used herein, “onto” and “on to” have been used interchangeably.

It will be understood that when an element or layer is referred to as being “attached to” another element or layer, the element or layer can be directly attached to the another element or layer or intervening elements or layers. In contrast, when an element is referred to as being “attached directly to” another element or layer, there are no intervening elements or layers present. It will be understood that such relationship also is to be understood with regard to: “secured to” versus “secured directly to”; “provided to” versus “provided directly to”; “connected to” versus “connected directly to” and similar language.

As used herein, the term “and/or” includes any and all combinations of one or more of the associated listed items.

It will be understood that, although the terms first, second, third, etc., may be used herein to describe various features, elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper”, “top”, “bottom”, “left”, “right” and the like, may be used herein for ease of description to describe the relationship of one element or feature to another element(s) or feature(s) as illustrated in the drawing figures. It will be understood that spatially relative terms are intended to encompass different orientations of structures in use or operation, in addition to the orientation depicted in the drawing figures. For example, if a device in the drawing figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

The terminology used herein is for the purpose of describing particular embodiments only and is not intended to be limiting of the disclosure. As used herein, the singular forms “a”, “an” and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to diagrams and/or cross-section illustrations, for example, that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of components illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment.

Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

Embodiments are also intended to include or otherwise cover methods of using and methods of manufacturing any or all of the elements disclosed above.

While the subject matter has been described in detail with reference to exemplary embodiments thereof, it will be apparent to one skilled in the art that various changes can be made, and equivalents employed, without departing from the scope of the disclosure.

All related art references and art references discussed herein are hereby incorporated by reference in their entirety. All documents referenced herein are hereby incorporated by reference in their entirety.

In conclusion, it will be understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

What is claimed is:

1. A cell comprising:
a housing;
an anode current collector, in the housing, including a first connection, and the anode current collector including a first plate with perforations and a second plate with perforations, the anode current collector further including a tab that connects the first plate and the second plate;
a cathode current collector, in the housing, including a second connection;
a first anode, in the housing, provided between the cathode current collector and the first plate;
a second anode, in the housing, provided between the cathode current collector and the second plate; and
a cathode, in the housing, provided adjacent to the cathode current collector.

2. The cell of claim 1, the perforations of the first plate and the perforations of the second plate are diamond in shape.

3. The cell of claim 1, the perforations of the first plate and the perforations of the second plate are circular in shape.

4. The cell of claim 1,
the first plate connected to a first side portion of the tab, and
the second plate connected to a second side portion of the tab.

5. The cell of claim 4, the tab having at least one aperture.

6. The cell of claim 5, the tab in the form of a bridge plate.

7. The cell of claim 6, wherein (a) the first plate oriented at substantially right angles to the bridge plate, and (b) the second plate oriented at substantially right angles to the bridge plate.

8. The cell of claim 7, the first plate being flat and the second plate being flat.

9. The cell of claim 4, the first plate having a first shape and the second plate having a second shape, and the first shape and the second shape being the same shape.

10. The cell of claim 9, the same shape including a first end and a second end, with the first end being rounded and the second end defined by two corners and linear edge extending between such two corners.

11. The cell of claim 10, further including a header assembly that is attached to the housing.

12. The cell of claim 11, the header assembly provided along the linear edge.

13. The cell of claim 1, the first connection, of the anode current collector, being a first tab, and the first tab extending from the first plate of the anode current collector.

14. The cell of claim 13, the second connection, of the cathode current collector, being a second tab, and the second tab extending from a body of the cathode current collector.

15. The cell of claim 14, the first connection being a negative connection of the anode and the second connection being a positive connection of the cathode.

16. The cell of claim 15, further including a header assembly that is attached to the housing, and the first tab and the second tab respectively connected to respective pass-through connections, through the header assembly, so as to provide electrical connection exterior of the cell.

17. The cell of claim 1, the anode constituted by a lithium coupon.

18. The cell of claim 1, the cathode constituted by a cathode pellet.

19. The cell of claim 1, wherein:
the first plate connected to a first side portion of the tab, and
the second plate connected to a second side portion of the tab; and
the tab having a plurality of apertures that include a first aperture and a second aperture, and the first aperture positioned over the second aperture in the tab, and the first aperture and the second aperture each being centered in the tab between the first side portion and the second side portion.
